(19) United States
(12) Patent Application Publication
(10) Pub. No.: US 2004/0111257 A1
(43) Pub. Date: Jun. 10, 2004

(54) Transcoding apparatus and method between CELP-based codecs using bandwidth extension

(76) Inventors: Jong Mo Sung, Daejeon-city (KR); Do Young Kim, Daejeon-city (KR); Bong Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/704,509

(22) Filed: Nov. 6, 2003

(30) Foreign Application Priority Data
Dec. 9, 2002 (KR) 2002-77769

(51) Int. Cl. G10L 19/04

(52) U.S. Cl. 704/219

(57) ABSTRACT

A transcoding apparatus and method between CELP-based codecs using bandwidth extension are provided. The transcoding apparatus between CELP-based codes using bandwidth extension comprises a formant parameter converter which extracts formant parameters in a narrowband CELP format from an input narrowband bitstream, and converts the extracted CELP format formant parameters into formant parameters in a wideband CELP format; an excitation signal parameter converter which converts excitation signal parameters in a narrowband CELP format of an input narrowband bitstream, into excitation signal parameters in a wideband CELP format; and a quantizer which quantizes the wideband CELP format formant parameters converted in the formant parameter converter and the wideband CELP formant excitation signal parameter converted in the excitation signal parameter converter, respectively, in an output CELP format. The transcoding apparatus can reduce degradation of voice quality, delay, and computational load, and by additionally generating information corresponding to the high band of wideband voice, enables high quality voice communications between networks having different bandwidths.

This application claims priority from Korean Patent Application No. 2002-77769, filed Dec. 9, 2002, the contents of which are incorporated herein by reference in their entirety.

### BACKGROUND OF THE INVENTION

1. Field of the Invention

The present invention relates to code-excited linear prediction (CELP)-based voice coding, and more particularly, to a transcoding apparatus and method between CELP-based codecs using bandwidth extension from a narrowband to a wideband.

2. Description of the Related Art

A technology to transmit voice in the form of digital signals is widely used in wireless telecommunications and in voice over IP (VoIP) networks, which have been attracting much attention recently, in addition to wired telecommunications such as the conventional telephone networks. If voice is simply sampled, digitized, and then transmitted, a data transmission rate of about 64 kbps (in the case of sampling at 8 kHz and coding each sample with 8 bits) is needed. However, if voice analysis and appropriate coding are used, voice can be transmitted at a much lower transmission rate.

An apparatus which extracts parameters from a voice production model and compresses voice is usually referred to as a vocoder. This apparatus comprises a coder which analyzes voice in order to extract parameters from input voice, and decoder which re-synthesizes voice from parameters transmitted through a transmission channel. Voice is divided into units of blocks referred to as a frame (or subframe) on time axis and then processed.

A linear prediction-based time-domain vocoder has been widely used till recently. This linear prediction technique is a method by which correlations of a current sample to past samples are extracted and only those parts that have no relation with the past samples are encoded. A basic linear prediction filter predicts a current sample with linear combination of past samples.

The function of a vocoder is to compress a voice signal at a low bit rate by removing redundancy existing in voice itself. Generally, voice has short-term redundancy due to filtering actions of a mouth and a tongue, and long-term redundancy due to vibration of the vocal chords. In a CELP coder, these two actions are modeled with respective filters, referred to as a short-term formant filter and a long-term pitch filter, respectively. Through these two filters, redundancies of a signal are removed and the remaining signal is modeled as white Gaussian noise or multi-pulse and the like and encoded.

The base of this technology is calculation of parameters of the two digital filters. The formant filter or linear predictive coding (LPC) filter performs a short-term prediction process of a voice waveform, while the pitch filter performs a long-term prediction process. One of excitation signals which make a signal finally synthesized the closest to the original voice signal is determined in an excitation codebook. Accordingly, parameters transmitted through a channel are broken down into three types, a formant (or LPC) filter coefficients, a pitch filter coefficients, and an excitation codebook index.

FIG. 1 is a schematic block diagram of an ordinary CELP vocoder comprising a encoder 102, a channel 104, and a decoder 106. Here, the channel 104 can be a communication channel, a storage medium and the like. The encoder 102 receives digitized input voice, extracts parameters expressing the characteristic of the voice, quantizes the result, and generates a bitstream to be transmitted through the channel 104. The decoder 106 restores the voice waveform from the received bitstream.

Meanwhile, various types of CELP vocoders are in use now. In order to successfully decode a bitstream encoded in a predetermined CELP format, the same CELP model as the encoder should be applied. If different communications networks employ their own CELP codecs, they need an apparatus for converting one CELP format into another CELP format.

FIG. 2 is a block diagram of a tandem coding system for converting an input CELP format into an output CELP format having different voice bandwidths respectively. The system comprises an input CELP format decoder 202, a voice bandwidth converter 204, and an output CELP format encoder 206. The input CELP format decoder 202 decodes an input bitstream in order to re-synthesize the original voice. The voice bandwidth converter 204 converts the sampling frequency of voice so that the voice re-synthesized in the input CELP format decoder 202 fits an output format. The output CELP format encoder 206 again encodes the voice, whose bandwidth was converted in the voice bandwidth converter 204, into an output CELP format.

This tandem coding method has shortcomings of voice quality degradation, delay increase, and computational complexity increase that occur because of many steps of the encoder and decoder. In addition, when transcoding from a narrowband codec format to a wideband codec format is performed, high quality voice cannot be transmitted because it simply changes a sampling frequency and therefore lacks information on a high band.

### SUMMARY OF THE INVENTION

The present invention provides a transcoding apparatus and method between CELP-based codecs using bandwidth extension, by which when transcoding from a narrowband CELP-based codec to a wideband CELP-based codec is performed, encoding efficiency is increased and by generating voice information corresponding to the high band of wideband voice, high quality voice can be transmitted.

The present invention also provides a computer readable medium having embodied thereon a program code for executing the transcoding method in a computer.

According to an aspect of the present invention, there is provided a transcoding apparatus between code-excited linear prediction (CELP)-based codecs using bandwidth extension, the apparatus comprising a parameter converter which extracts formant parameters in a narrowband CELP format from an input narrowband bitstream, and converts the extracted formant parameters into formant parameters in a wideband CELP format; an excitation signal parameter converter which converts excitation signal parameters in a narrowband CELP format of an input narrowband bitstream, into excitation signal parameters in a wideband CELP format; and a quantizer which quantizes the wideband CELP format formant parameters converted in the formant parameter converter and the wideband CELP format excitation signal parameter converted in the excitation signal parameter converter, respectively, in an output CELP format.

According to another aspect of the present invention, there is provided a transcoding method between CELP-based codecs using bandwidth extension, the method comprising: (a) extracting formant parameters in a narrowband CELP format from an input narrowband bitstream, and converting the extracted formant parameters into formant parameters in a wideband CELP format; (b) converting excitation signal parameters in a narrowband CELP format of an input narrowband bitstream, into excitation signal parameters in a wideband CELP format; and (c) quantizing the wideband CELP format formant parameters and the wideband CELP format excitation signal parameter, respectively, in an output CELP format.

### BRIEF DESCRIPTION OF THE DRAWINGS

The above objects and advantages of the present invention will become more apparent by describing in detail preferred embodiments thereof with reference to the attached drawings in which:

FIG. 1 is a schematic block diagram of an ordinary CELP vocoder;

FIG. 2 is a block diagram of a conventional tandem coding system for converting an input CELP format into an output CELP format employing different voice bandwidth respectively;

FIG. 3 is a schematic block diagram of a transcoding apparatus from a narrowband CELP format bitstream to a wideband CELP format bitstream according to a preferred embodiment of the present invention;

FIG. 4 is a flowchart of a formant parameter conversion process performed in a formant parameter converter of the apparatus shown in FIG. 3;

FIG. 5 is a schematic block diagram of a formant bandwidth extender shown in FIG. 3;

FIG. 6 is a flowchart showing in detail an order conversion process performed in a formant order converter shown in FIG. 3;

FIG. 7 is a flowchart showing a frame rate conversion process performed in a formant frame rate converter shown in FIG. 3;

FIG. 8 is a flowchart showing an excitation signal parameter conversion operation performed in an excitation signal parameter converter shown in FIG. 3; and

FIG. 9 is a block diagram of a preferred embodiment of an excitation signal bandwidth extender shown in FIG. 3.

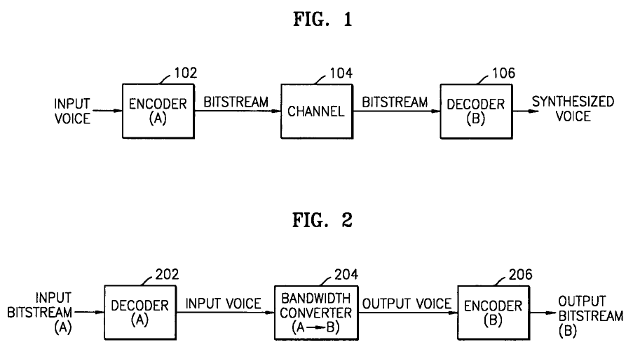

### DESCRIPTION OF THE PREFERRED EMBODIMENTS

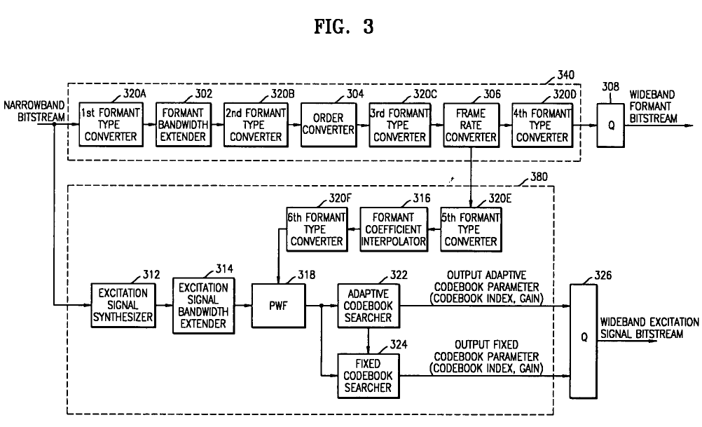

Referring to FIG. 3, the transcoding apparatus according to the present invention comprises a formant parameter converter 340, a formant coefficient quantizer 308, an excitation signal parameter converter 380, and an excitation signal quantizer 326.

Referring to FIG. 3, the formant parameter converter 340 converts a formant filter coefficient in a narrowband CELP format into a wideband CELP format in order to obtain a wideband formant parameter. More specifically, the formant parameter converter 340 comprises a formant bandwidth extender 302, a formant order converter 304, a formant frame rate converter 306, and 1st through 4th formant type converters 320A through 320D.

The 1st formant type converter 320A converts a types of narrowband formant parameter obtained from the input CELP bitstream into a type appropriate to the formant bandwidth extender 302, for example, a line spectral frequency (LSF). A bandwidth relates to the sampling frequency of voice and generally corresponds to a half of a sampling frequency. In order to transcode a formant parameter from a narrowband to a wideband (for example, in a case where one is a narrowband codec spanning from 0 Hz to 4 kHz band and the other is a wideband codec), a bandwidth extension process in a formant filter coefficient domain is needed. If formant coefficients from an input bitstream are the LSF type, it is not needed to pass the 1st formant type converter 320A.

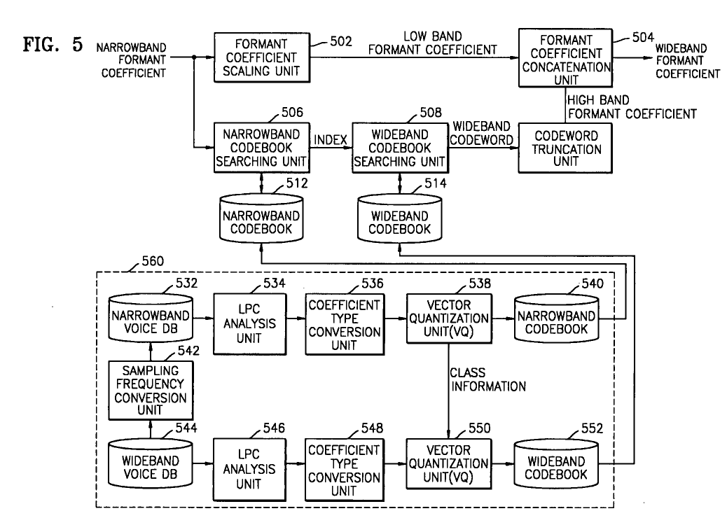

The formant bandwidth extender 302 receives LSF coefficients from the formant type converter 302, and extends their bandwidth from a narrowband to a wideband. The formant bandwidth extender 302 will be explained in detail referring to FIG. 5.

The 2nd formant type converter 320B receives the bandwidth-extended formant filter coefficients from the formant bandwidth extender 302, and converts their type into a formant coefficient type appropriate to order conversion, for example, into a reflection coefficient.

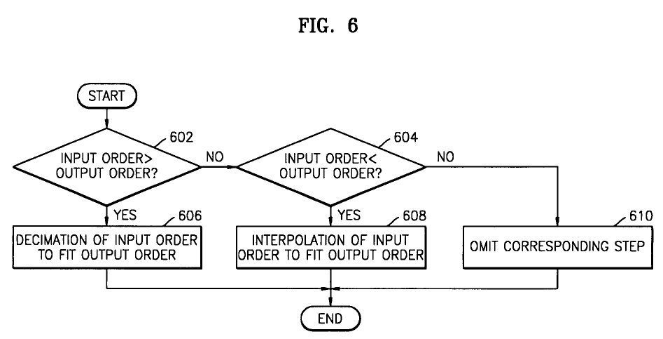

The formant order converter 304 receives the reflection coefficients converted in the 2nd formant type converter 320B, and converts the order of the reflection coefficient into an order specified in an output CELP format. The order conversion process performed in the formant order converter 304 will be explained in detail referring to FIG. 6.

The 3rd formant type converter 320C converts a type of the filter coefficients order-converted in the formant order converter 304, into a coefficient type appropriate to frame rate conversion, for example, into a line spectral pair (LSP) coefficient.

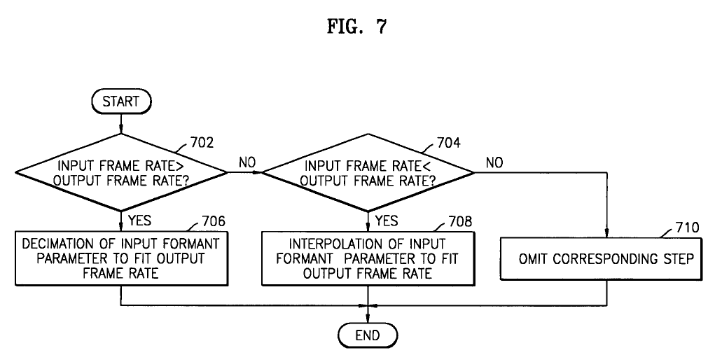

The formant frame rate converter 306 converts the frame rate of the LSP coefficients converted in the 3rd formant type converter 320C so that it fits the frame rate of the output CELP format. For the frame rate conversion, if CELP-based codecs use different frame size that is an analysis unit for voice in a CELP-based codec, the frame size should be adjusted to fit an output format for transcoding between such codecs. This means adjusting the number of frames analyzed per second between an input codec and an output codec. The frame rate conversion process performed in the formant frame rate converter 306 will be explained in detail referring to FIG. 7.

The 4th formant type converter 320D converts a type of the filter coefficient which is frame rate converted by the format frame rate converter 306, into a type of an output CELP format. If the output CELP codec uses an LSP type, this step is not needed.

Next, the formant coefficient quantizer 308 quantizes the formant filter coefficients of the output CELP format converted in the 4th formant type converter 320D through a way used in the output CELP codec.

The excitation signal parameter converter 380 converts an excitation signal parameter in a narrowband CELP format into a wideband CELP format in order to obtain a wideband excitation signal parameter. More specifically, the excitation signal parameter converter 380 comprises an excitation signal synthesizer 312, an excitation signal bandwidth extender 314, a formant coefficient interpolator 316, a perceptual weighted filter (PWF) 318, an adaptive codebook searcher 322, a fixed codebook searcher 324, and fifth and sixth formant type converters 320E, 320F.

The excitation signal synthesizer 312 extracts an excitation signal parameter from a narrowband bitstream in a narrowband CELP format, and by using the extracted excitation signal parameter, synthesizes a narrowband excitation signal. Generally, excitation signal parameters include an adaptive codebook index corresponding to a pitch component, and the gain of the codebook, and a fixed codebook index and the gain of the codebook, and the like. By using these parameters, the excitation signal synthesizer 312 synthesizes an excitation signal according to a method used in an input CELP format decoder.

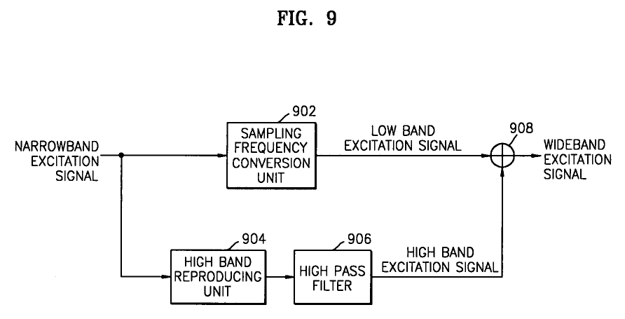

The excitation signal bandwidth extender 314 converts the narrowband excitation signal synthesized in the excitation signal synthesizer 312, into an excitation signal corresponding to the bandwidth of a wideband CELP formant. The excitation signal bandwidth extender 314 will be explained in detail referring to FIG. 9.

The 5th formant type converter 320E converts a type of the frame rate converted formant filter coefficients into a type appropriate to formant coefficient interpolation for the following subframe processing, for example, LSP type.

The formant coefficient interpolator 316 obtains formant coefficients corresponding to a subframe analysis unit through interpolation, according to an analysis unit of an excitation signal. Generally, a formant parameter exists in a frame unit, an excitation parameter exists in each subframe unit, and two or more subframes are in one frame. Accordingly, the formant coefficient interpolator 316 interpolates formant coefficients in a frame unit so as to obtain formant coefficients in subframe unit.

The 6th formant type converter 320F receives LSP coefficients corresponding to each subframe interpolated in the formant coefficient interpolator 316, and converts the LSP type into a formant type appropriate to the PWF 318, for example, into an LPC coefficient.

The PWF 318 is a filter for filtering the bandwidth extended excitation signal so that the resulting signal reflects the human perception characteristic. The PWF 318 is constructed using the LPC coefficients corresponding to a subframe converted in the 6th formant type converter 320F, and filters the excitation signal having the bandwidth of the wideband CELP format converted in the excitation signal bandwidth extender 314. By passing the bandwidth extended excitation signal through the PWF 318, the signal is converted into a signal reflecting the human perception characteristic.

Using the output signal of the PWF 318 as a target signal, the adaptive codebook searcher 322 searches a codebook corresponding to pitch information and calculates the corresponding adaptive codebook gain. This adaptive codebook searching process is identically performed as the output CELP codec does.

Subtracting the contribution of the adaptive codebook from the output signal of the PWF 318, the target signal for fixed codebook search is obtained. The fixed codebook searcher 324 searches the fixed codebook for the output CELP codec, and calculates the corresponding fixed codebook gain. This fixed codebook searching process is also identically performed as the output CELP codec does.

Next, the excitation signal quantizer 326 receives the codebook indexes and gains generated in the adaptive codebook searcher 322 and the fixed codebook searcher 324, as excitation parameters, and quantizes them in the output CELP codec format.

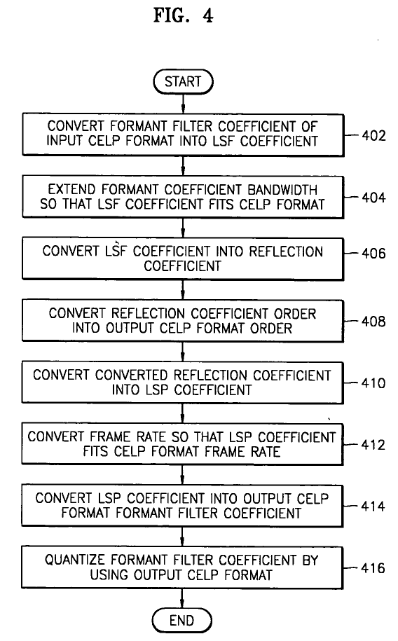

FIG. 4 is a flowchart of a formant parameter conversion process performed in the formant parameter converter of the apparatus shown in FIG. 3.

Referring to FIGS. 3 and 4, the formant type converter 320A converts a type of the formant filter coefficient, into a coefficient type appropriate to formant bandwidth extension, for example, an LSF coefficient, in step 402. At this time, if the coefficient type of the input narrowband bitstream is the LSF, this process is not needed.

After the step 402, the formant bandwidth extender 302 receives the LSF coefficients from the formant type converter 320A, and extends the bandwidth of the formant coefficients from a narrowband to a wideband to fit them to the output CELP format in step 404.

After the step 404, the second formant type converter 320B converts a type of the bandwidth extended formant filter coefficients into a formant coefficient type appropriate to order conversion, for example, a reflection coefficient, in step 406.

After the step 406, the formant order converter 304 converts the order of the reflection coefficients converted in the step 406, into an order of a model used in the output CELP format in step 408.

The 3rd formant type converter 320C converts a type of the filter coefficients, which is order-converted in the step 408, into a coefficient type appropriate to frame rate conversion, for example, an LSP coefficient, in step 410.

After the step 410, the frame rate converter 306 converts the frame rate of the LSP coefficients converted in the step 410, to fit them to the frame rate of the output CELP format in step 412.

After the step 412, the 4th formant type converter 320D converts the frame rate converted filter coefficients in the LSP format, into a formant filter coefficients type in the output CELP format in step 414. If the output CELP codec uses LSP type, this process is not needed.

After the step 414, the formant coefficient quantizer 308 quantizes the formant filter coefficients converted in the step 414 through a way used in the output CELP codec.

FIG. 5 is a schematic block diagram of the formant bandwidth extender 302 shown in FIG. 3, comprising a formant coefficient scaling unit 502, a formant coefficient concatenation unit 504, a narrowband codebook searching unit 506, a wideband codebook searching unit 508, and a codeword truncation unit 510.

The formant coefficient scaling unit 502 first scales narrowband formant coefficients sent by the first formant type converter 320A (Refer to FIG. 3), to fit them to a wideband formant parameter format, and obtains a formant coefficients corresponding to a low band. For example, if a narrowband CELP codec spans a bandwidth from 0 Hz to 4 kHz and a wideband CELP codec spans a bandwidth from 0 Hz to 8 kHz, the scaling factor at the LSF (in radian) domain is 0.5 (=4 kHz/8 kHz).

By using the resulting low band formant coefficients from the formant coefficient scaling unit 502 and referring to a narrowband codebook 512 trained in advance, the narrowband codebook searching unit 506 finds an index for a closest codeword and provides the index to the wideband codebook searching unit 508.

Referring to a wideband codebook 514, the wideband codebook searching unit 508 searches for a wideband codeword corresponding to the index found by the narrowband codebook searching unit 506. Generally, low band voice information (e.g. 0˜4 kHz) relates to high band voice information (e.g. 4˜8 kHz). Accordingly, using the low band codeword index provided by the narrowband codebook searching unit 506, the wideband codebook searching unit 508 can search for a wideband codeword.

The codeword truncation unit 510 truncates the wideband codeword found in the wideband codebook searching unit 508 so that only the component corresponding to the high band of the wideband remains. Thus, through the wideband codebook searching unit 508 and the codeword truncation unit 510, voice information of the high band can be generated.

By adding the low band formant coefficients obtained in the format coefficient scaling unit 502 and the high band formant coefficients obtained in the codeword truncation unit 510, the formant coefficient concatenation unit 504 generates a bandwidth extended wideband formant coefficients.

Meanwhile, in order to obtain the narrowband codebook 512 and the wideband codebook 514, a predetermined training process is needed.

Referring to FIG. 5, first, a narrowband voice database 532 is generated from a prepared wideband voice database 544 through a sampling frequency conversion unit 542.

1st and 2nd linear predictive coding (LPC) analysis unit 534 and 546 obtain LPC coefficients through the linear predictive coding analysis method respectively, from the narrowband voice DB 532 and the wideband voice DB 544.

1st and 2nd coefficient type conversion units 536 and 548 convert LPC coefficients obtained by the 1st and 2nd linear predictive coding analysis units 534 and 546, respectively, into formant coefficients appropriate to codebook training. Through theses processes, formant coefficients sets corresponding to the narrowband voice DB 532 and the wideband voice DB 544, respectively, are generated.

A 1st vector quantization unit 538 quantizes narrowband formant coefficients vectors and generates a narrowband codebook 540 having a desired number of representative values (codewords). This vector quantization can be performed using the famous LBG (Linde, Buzo, and Gray) algorithm.

A 2nd vector quantization unit 550 generates a wideband codebook 552 using the class information on each formant coefficient vectors additionally obtained in the process for generating the narrowband codebook 540. Thus the obtained codebook pair 540 and 552 can be referred to by an identical index.

FIG. 6 is a flowchart showing in detail an order conversion process performed in the formant order converter 304 shown in FIG. 3.

Referring to FIG. 6, if an input order is greater than an output order in step 602, the input order is decimated to fit the output order in step 606. Here, the decimation process in the step 606 can be simply performed by replacing unnecessary coefficients greater than the output model order with zeros.

If the input order is less than the output order in step 604, the input order is interpolated to fit the output order in step 608. Here, the interpolation process in the step 608 can be performed by filling the same number of zeros as the lacked order. If the input order is the same as the output order, this order conversion process is not needed and is omitted in step 610.

FIG. 7 is a flowchart showing a frame rate conversion process performed in the formant frame rate converter 306 shown in FIG. 3.

Referring to FIGS. 3 and 7, if an input frame rate is higher than an output frame rate in step 702, the formant frame rate converter 306 decimates the input LSP coefficients to fit them to the output frame rate in step 706.

If the input frame rate is lower than the output frame rate in step 704, the formant frame rate converter 306 interpolates the input LSP coefficients to fit them to the output frame rate in step 708. Here, in the decimation step 706 of the LSP coefficients, the output formant coefficients can be obtained, by applying appropriate weighting values compensating the frame rate mismatch to input formant coefficients of a current frame and those of previous frames, and then adding the coefficients. For example, if input CELP codec uses 10 ms frame size (e.g. frame rate is 100 frames per second) and the output CELP codec uses 20 ms frame size (e.g. frame rate is 50 frames per second), the following equation can be applied for decimation step:

lspₒᵤₜ⁽ⁱ⁾=α·lsp_{current}⁽ⁱ⁾+(1−α)·lspₚᵣₑᵥᵢₒᵤₛ⁽ⁱ⁾

where, lspₒᵤₜ is the output formant coefficient of the frame rate converter, lsp_{current} is the input formant coefficient in the current frame, and lspₚᵣₑᵥᵢₒᵤₛ is the input formant coefficient in the previous frame. i indicates the order index and α is a weighting factor.

Also, in the interpolation step 708 of the LSP coefficients, frame rate converted LSP coefficients can be obtained by applying appropriate weighting values to the input formant coefficients of a previous frame and the input formant coefficients of a current frame and summing the weighted coefficients. For example, if input CELP codec uses 20 ms frame size (e.g. the frame rate is 50 frames per second) and the output CELP codec uses 10 ms frame size (e.g. the frame rate is 100 frames per second), the following equation can be applied for interpolation step:

lspₒᵤₜ₁⁽ⁱ⁾=α·lsp_{current}⁽ⁱ⁾+(1−α)·lspₚᵣₑᵥᵢₒᵤₛ⁽ⁱ⁾

lspₒᵤₜ₂⁽ⁱ⁾=β·lsp_{current}⁽ⁱ⁾+(1−β)·lspₚᵣₑᵥᵢₒᵤₛ⁽ⁱ⁾

where, lspₒᵤₜ₁ is the first output formant coefficient of the frame rate converter, lspₒᵤₜ₂ is the second output formant coefficient of the frame rate converter, lsp_{current} is the input formant coefficient in the current frame, and lspₚᵣₑᵥᵢₒᵤₛ is the input formant coefficient in the previous frame. i indicates the order index, and α and β are weighting factors.

If the input frame rate is the same as the output frame rate, this process is not needed and is omitted in step 710.

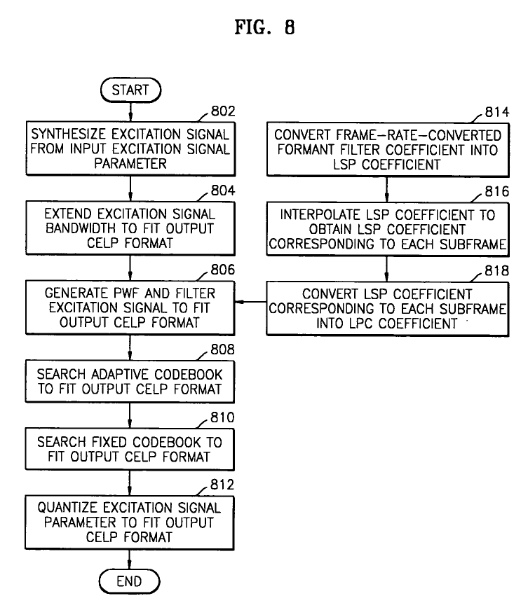

FIG. 8 is a flowchart showing an excitation signal parameter conversion operation performed in the excitation signal parameter converter 380 shown in FIG. 3.

Referring to FIGS. 3 and 8, the excitation signal synthesizer 312 extracts excitation signal parameters from the input CELP format narrowband bitstream and using the extracted excitation signal parameters, synthesizes a narrowband excitation signal in step 802.

After the step 802, the excitation signal bandwidth extender 314 converts the narrowband excitation signal synthesized in the step 802, into an excitation signal corresponding to the bandwidth of the wideband CELP format in step 804.

Meanwhile, the 5th formant type converter 320E converts a type of the frame rate converted formant filter coefficients into a coefficient type appropriate to formant coefficient interpolation in step 814. The formant type converter 320E may pass the frame rate converted LSP coefficient without change.

After the step 814, according to a predetermined frame analysis unit, the formant coefficient interpolator 316 obtains formant coefficients corresponding to the each subframe analysis unit, through interpolation in step 816. For example, when the excitation signal is analyzed in units of subframes, the formant coefficients corresponding to each subframe are obtained through the interpolation. More specifically, by interpolating between the LSP coefficients of the previous frame and the LSP coefficients of the current frame with applying an appropriate weighting value for each subframe, a formant coefficients corresponding to each subframe can be obtained. This process is similar to the interpolation step 708 in the formant frame rate converter 306.

The 6th formant type converter 320F receives the LSP formant coefficients corresponding to each subframe interpolated in the step 816, and converts them into coefficients in a formant filter type appropriate for the PWF, for example, an LPC coefficient, in step 818.

The PWF 318 is constructed from the LPC coefficients corresponding to the subframe converted in the step 818, and filters the excitation signal having the bandwidth of the wideband CELP format converted in the step 804, in step 806. Thus, using the PWF 318, the excitation signal is converted to a signal reflecting the human perception characteristic.

After the step 806, regarding the output signal of the PWF 318 as a target signal, the adaptive codebook searcher 322 searches for a codebook corresponding to pitch information to fit the output CELP format, and calculates the corresponding codebook gain in step 808. This adaptive codebook searching process is identically performed as the output CELP codec does.

Also, after the step 806, subtracting the contribution of the adaptive codebook from the output signal of the PWF 318, the target signal for fixed codebook search is obtained. The fixed codebook searcher 324 searches for the fixed codebook to fit the output CELP format, and calculates the gain of the corresponding codebook in step 810. This fixed codebook searching process is also identically performed as the output CELP codec does.

FIG. 9 is a block diagram of a preferred embodiment of an excitation signal bandwidth extender 314 shown in FIG. 3. The excitation signal bandwidth extender according to a preferred embodiment comprises a high band reproducing unit 904, a high pass filter 906, a sampling frequency conversion unit 902, and an adder 908.

Referring to FIG. 9, the sampling frequency conversion block 902 converts a narrowband excitation signal sent by the excitation signal synthesizer 312, into a low band excitation signal having a sampling frequency corresponding to the wideband CELP format. The sampling frequency conversion unit 902 comprises an up-sampling and low band pass filters as generally well known.

The high band reproducing unit 904 regenerates an excitation signal component corresponding to the high band of the wideband, from the original narrowband excitation signal sent by the excitation signal synthesizer 312. As a high band reproducing method, the well known methods such as spectrum folding and non-linear distortion can be used.

The high pass filter 906 passes only the high band of the excitation signal reproduced in the high band reproducing unit 904, and obtains an excitation signal component corresponding to the high band of the overall wideband excitation signal.

The adder 908 adds the low band excitation signal generated in the sampling frequency converter 902 and the high band excitation signal generated in the high pass filter 906, and generates a wideband excitation signal.

The present invention may be embodied in a code, which can be read by a computer, on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

Optimum embodiments have been explained above and are shown. However, the present invention is not limited to the preferred embodiment described above, and it is apparent that variations and modifications by those skilled in the art can be effected within the spirit and scope of the present invention defined in the appended claims. Therefore, the scope of the present invention is not determined by the above description but by the accompanying claims.

According to the transcoding apparatus and method between CELP-based codecs using bandwidth extension of the present invention as described above, degradation of voice quality, delay, and computation load can be minimized, and by additionally generating information corresponding to the high band of wideband voice, high quality voice communication between networks having different bandwidths is enabled.

What is claimed is:

1. A transcoding apparatus between code-excited linear prediction (CELP)-based codecs using bandwidth extension, the apparatus comprising:
a formant parameter converter which extracts formant parameters from an input narrowband bitstream, and converts the extracted formant parameters into formant parameters in an output wideband CELP format;
an excitation signal parameter converter which converts excitation signal parameters from an input narrowband bitstream, into excitation signal parameters in an output wideband CELP format; and
a quantizer which quantizes the wideband CELP format formant parameters converted in the formant parameter converter and the wideband CELP format excitation signal parameter converted in the excitation signal parameter converter, respectively in an output CELP format.

2. The apparatus of claim 1, wherein the formant parameter converter comprises:
a formant bandwidth extender which extracts formant parameters from an input narrow band bitstream, and extends the bandwidth of the extracted narrowband CELP format formant parameters, from a narrowband to a wideband;
a formant order converter which converts the order of the bandwidth-extended formant parameters, into the order of an output CELP format; and
a formant frame rate converter which adjusts the frame rate of the order-converted formant parameters in order to fit the frame rate of the output CELP format, and provides the frame rate converted formant parameters to the quantizer.

3. The apparatus of claim 1, wherein the formant parameter converter comprises:
a 1 st formant type converter which extracts formant parameters from an input narrowband bitstream, and converts a type of the extracted formant parameters in the narrowband CELP format into type a type suitable for formant bandwidth extension;
a formant bandwidth extender which extends the bandwidth of narrowband parameters whose type is converted in the 1st formant type converter, from a narrowband to a wideband;
a 2nd formant type converter which converts the type of the bandwidth-extended formant parameters, into a formant type suitable for order conversion;
a formant order converter which converts the order of the formant parameters whose type is converted in the 2nd formant type converter, into the order of the output CELP format;
a 3rd formant type converter which converts the type of the order-converted formant parameter, into a formant type appropriate to frame rate conversion;
a formant frame rate converter which adjusts the frame rate of the formant parameters whose type is converted in the 3rd formant type converter, to fit the frame rate of the output CELP format; and
a 4th formant type converter which converts the type of the frame rate converted formant parameter, into a formant type for quantization in the output CELP format, and provides the converted formant coefficients to the quantizer.

4. The apparatus of claim 3, wherein the 1st formant type converter converts a type of the extracted formant parameters in the narrowband CELP format, into a line spectral frequency (LSF) type.

5. The apparatus of claim 3, wherein the 2nd formant type converter converts the type of the formant parameters whose bandwidth is extended to the wideband, into a reflection coefficient type.

6. The apparatus of claim 3, wherein the 3rd formant type converter converts the type of the formant parameters whose order is adjusted, into a line spectral pair (LSP) type.

7. The apparatus of any one of claims 1 and 2, wherein the formant bandwidth extender comprises:
a formant coefficient scaling unit which scales the received narrowband formant coefficients to extend the bandwidth in a formant parameter domain, and obtains formant coefficients corresponding to a low band part of an overall wideband formant coefficients. Here, the scaling factor can be determined by a ratio of bandwidth in an input narrowband CELP format and bandwidth in an output wideband CELP format;
a narrowband codebook searching unit which by using the received narrowband formant coefficient and referring to a narrowband codebook trained in advance, finds an index of a closest codeword;
a wideband codebook searching unit which by referring to an wideband codebook trained in advance, searches for a wideband codeword corresponding to the index of the narrowband codeword searched by the narrowband codebook searching unit;
a codeword truncation unit which truncates the wideband codeword searched in the wideband codebook searching unit so that only a component corresponding to the high band of the wideband remains;
a formant coefficient concatenation unit which adds the low band formant coefficients obtained in the formant coefficient scaling unit and the high band formant coefficients obtained in the codeword truncation unit and generates bandwidth extended wideband formant coefficients; and
a codeword training unit which generates the narrowband codebook and the wideband codebook through training.

8. The apparatus of claim 7, wherein the codeword training unit comprises:
a wideband voice database which stores wideband voice samples;
a sampling frequency conversion unit which generates narrowband voice samples through the sampling frequency conversion of the wideband voice samples;
a narrowband voice database which stores narrowband voice samples generated by the sampling frequency conversion unit;
a 1st linear predictive coding analysis unit which generates LPC coefficients through linear predictive coding analysis method used in a narrowband CELP codec for the narrowband voice database, and a 2nd linear predictive coding analysis unit which generates LPC coefficients through linear predictive coding analysis method used in a wideband CELP codec for the wideband voice database;
a 1st coefficient type conversion unit which generates the narrowband formant coefficients by converting a type of the LPC coefficients generated in the 1st linear predictive coding analysis unit, into a formant coefficient type appropriate to training, and a 2nd coefficient type conversion unit which generates the wideband formant coefficients by converting the type of the LPC coefficients generated in the 2nd linear predictive coding analysis unit, into formant coefficients type appropriate to training;
a 1st vector quantization unit which trains the narrowband codebook having a desired number of codewords, by quantizing the narrowband formant coefficients vectors; and
a 2nd vector quantization unit which trains the wideband codebook using the class information on each formant coefficients vector generated additionally in the process for training the narrowband codebook.

9. The apparatus of any one of claims 2 and 3, wherein the formant order converter, if an input order is greater than an output order, decimates the input order to fit the output order, and if an input order is less than an output order, interpolates the input order to fit the output order.

10. The apparatus of claim 9, wherein in the decimation of the order conversion, the coefficients greater than the output order are replaced by 0 and in the interpolation of order conversion, the same number of 0's as the lacked order are filled.

11. The apparatus of any one of claims 2 and 3, wherein the formant frame rate converter, if an input frame rate is higher than an output frame rate, decimates the coefficients of the input parameter to fit the output frame rate, and
if the input frame rate is lower than the output frame rate, interpolates the coefficients of the input parameter to fit the output frame rate.

12. The apparatus of claim 11, wherein in the decimation of the frame rate conversion, the decimated formant coefficients are obtained by applying appropriate weighting to input formant coefficients of a current frame and those of a previous frame and then adding the weighted coefficients, and in the interpolation of the frame rate conversion, frame rate converted coefficients are obtained by applying appropriate weighting to the input formant coefficients of a current frame and the input formant coefficients of previous frames and summing the weighted coefficients.

13. The apparatus of claim 1, wherein the excitation signal parameter converter comprises:
an excitation signal synthesizer which extracts excitation signal parameters from an input narrowband bitstream and using the extracted excitation signal parameters, synthesizes a narrowband excitation signal;
an excitation signal bandwidth extender which converts the narrowband excitation signal synthesized in the excitation signal synthesizer, into an excitation signal corresponding to a bandwidth of a output wideband CELP format;
a formant coefficient interpolator which obtains formant coefficients corresponding to a analysis unit of an excitation signal called subframe, by interpolating the formant coefficients converted in the formant parameter converter to the formant coefficients set corresponding to each subframes;
a perceptual weighted filter (PWF) which is constructed using the formant coefficients obtained through interpolation in the formant coefficient interpolator, and, filters the wideband excitation signal from the excitation signal bandwidth extender;
an adaptive codebook searcher which regarding the output signal of the PWF as a target signal, searches an adaptive codebook corresponding to pitch information to fit an output CELP format, calculates the gain of the corresponding codebook, and provides the calculated gain and the searched adaptive codebook index to the quantizer; and
a fixed codebook searcher which, using a target signal of a fixed codebook obtained by subtracting the contribution of the adaptive codebook from the output signal of the PWF, searches for a fixed codebook to fit an output CELP format, calculates the gain of the corresponding codebook, and provides the calculated gain and the searched fixed codebook index to the quantizer.

14. The apparatus of claim 13, wherein the frame analysis unit of the excitation signal is a subframe unit.

15. The apparatus of claim 13, further comprising:
a 5th formant type converter which converts a type of the formant coefficients, which are converted into wideband CELP format formant parameters in the formant parameter converter, into a formant coefficient type appropriate to formant coefficient interpolation; and
a 6th formant type converter which converts a type of the formant coefficients, which are obtained in the formant coefficient interpolator through interpolation, into a formant type appropriate to the PWF.

16. The apparatus of claim 15, wherein the 6th formant type converter converts the interpolated formant coefficient into a linear predictive coding (LPC) coefficient.

17. The apparatus of claim 13, wherein the excitation signal bandwidth extender comprises:
a sampling frequency conversion unit which converts the narrowband excitation signal sent by the excitation signal synthesizer, into a low band component of wideband excitation signal having a sampling frequency corresponding to a wideband CELP format;
a high band reproducing unit which regenerates an excitation signal component corresponding to the high band of a wideband excitation signal, from the narrowband excitation signal sent by the excitation signal synthesizer;
a high pass filter which extracts only an excitation signal component corresponding to the high band of a wideband, by high pass filtering the excitation signal produced in the high band reproducing unit; and
an adder which generates a overall wideband excitation signal by adding the low band excitation signal generated in the sampling frequency converter and the high band excitation signal generated in the high band pass filter.

18. A transcoding method between CELP-based codecs using bandwidth extension, the method comprising:
(a) extracting formant parameters from an input narrowband bitstream, and converting the extracted formant parameters into formant parameters in an output wideband CELP format;
(b) converting excitation signal parameters extracted from an input narrowband bitstream, into excitation signal parameters in an output wideband CELP format; and
(c) quantizing the wideband CELP format formant parameters and the wideband CELP formant excitation signal parameter, respectively, in an output CELP format.

19. The method of claim 18, wherein the step (a) comprises:
(a11) extracting formant parameters from a narrowband bitstream, and extending the bandwidth of the extracted narrowband CELP format formant parameters, from a narrowband to a wideband;
(a12) converting the order of the formant parameters, which are bandwidth-extended to a wideband in the step (a11), into the order of an output CELP format; and
(a13) converting the frame rate of the formant parameters, whose order is converted into the order of the output CELP format in the step (a12), in order to fit the frame rate of the output CELP format.

20. The method of claim 18, wherein the step (a) comprises:
(a21) extracting formant parameters from a narrowband bitstream, and converting a type of the extracted formant parameters in the narrowband CELP format into a type suitable for formant bandwidth extension;
(a22) extending the bandwidth of narrowband parameters whose type is converted in the step (a21), from a narrowband to a wideband;
(a23) converting the type of the formant parameters whose bandwidth is extended to a wideband in the step (a22), into a formant type suitable for order conversion;
(a24) converting the order of the formant parameters whose type is converted in the step (a23), into the order of the output CELP format;
(a25) converting the type of the formant parameter whose order is converted, into a formant type appropriate to frame rate conversion;
(a26) converting the frame rate of the formant parameters whose type is converted in the step (a25), to fit the frame rate of the output CELP format; and
(a27) converting the type of the formant parameter whose frame rate is converted, into a formant type for quantization in the output CELP format.

21. The method of any one claims 19 and 20, wherein the step for extending the bandwidth of the narrowband formant parameters to a wideband comprises:
(a11_{—}1) scaling the narrowband formant coefficients in the step (a21) to extend the bandwidth in a formant parameter domain, and obtaining formant coefficients corresponding to a low band part of an overall wideband formant coefficients;
(a11_{—}2) by using the narrowband formant coefficients in the step (a21) and referring to a narrowband codebook trained in advance, finding an index of a closest formant coefficients codeword;
(a11_{—}3) by referring to a wideband codebook trained in advance, searching for a wideband formant coefficients codeword corresponding to the index found in the step (a11_{—}2);
(a11_{—}4) truncating the wideband codeword found in the step (a11_{—}3) so that only a component corresponding to the high band of the wideband remains; and
(a11_{—}5) adding the low band formant coefficients obtained in the step (a11_{—}1) and the high band formant coefficients obtained in the step (a11_{—}4) and generating bandwidth extended wideband formant coefficients.

22. The method of claim 21, wherein the training in the steps (a11_{—}2) and (a11_{—}3) comprises:
(a11_{—}21) generating narrowband voice samples by performing sampling frequency conversion of wideband voice samples stored in a wideband voice database for training, and generating a narrowband voice database for storing these narrowband voice samples;
(a11_{—}22) generating LPC coefficients for the narrowband voice database through linear predictive coding analysis methods used in narrowband CELP codec and LPC coefficients for the wideband voice database through linear predictive coding analysis methods used in wideband CELP codec, respectively;
(a11_{—}23) generating the narrowband formant coefficients set and the wideband formant coefficients set, by converting the LPC coefficients generated in the step (a11_{—}22), into formant type appropriate to training;
(a11_{—}24) training the narrowband codebook having a desired number of codewords, by quantizing the narrowband formant coefficients vectors generated in the step (a11_{—}23); and
(a11_{—}25) training the wideband codebook using class information on each formant coefficients vectors generated additionally in the process for training the narrowband codebook in the step (a11_{—}24).

23. The method of any one of claims 19 and 20, wherein the step for converting the formant order comprises:
(a12_{—}1) if an input order is greater than an output order, performing decimation by replacing the coefficients greater than the output order by 0s; and
(a12_{—}2) if an input order is less than an output order, performing interpolation, by filling the same number of 0's as lacked order in order to fit the input order to the output order.

24. The method of any one of claims 19 and 20, wherein the step for converting the formant frame rate comprises:
(a13_{—}1) if an input frame rate is higher than an output frame rate, decimating the coefficients of the input formant to fit the output frame rate; and
(a13_{—}2) if the input frame rate is lower than the output frame rate, interpolating the coefficients of the input formant to fit the output frame rate, wherein in the decimation of the frame rate conversion, the decimated formant coefficients are obtained by applying appropriate weighting to input formant coefficients of a current frame and those of a previous frame and then adding the weighted coefficients, and in the interpolation of the frame rate conversion, the interpolated formant coefficients are obtained by applying appropriate weighting to the input formant coefficients of a current frame and the input formant coefficients of previous frames and adding the weighted coefficients.

25. The method of claim 18, wherein the step (b) comprises:
(b1) extracting excitation signal parameters from a narrowband bitstream and using the extracted excitation signal parameters, synthesizing a narrowband excitation signal;
(b2) converting the narrowband excitation signal synthesized in the step (b1), into an excitation signal corresponding to a bandwidth of a wideband CELP format;
(b3) obtaining formant coefficients for each subframe unit in a analysis unit of an excitation signal, by interpolating the formant coefficients, which are converted into wideband CELP format formant parameters in the step (a);
(b4) converting the formant coefficients obtained through interpolation in the step (b3), into a PWF coefficients corresponding to the output CELP format, and using the PWF constructed from the coefficients, filtering the wideband excitation signal generated in the step (b2);
(b5) with the signal filtered in the step (b4) as a target signal for adaptive codebook search, searching an adaptive codebook corresponding to pitch information to fit an output CELP format, and calculating the gain of the corresponding codebook; and
(b6) by taking the signal generated in the step (b4) subtracting the contribution of the adaptive codebook, as a target signal for fixed codebook search, searching for a fixed codebook to fit an output CELP format, and calculating the gain of the corresponding codebook.

26. The method of claim 25, further comprising:
(b7) converting the type of the formant coefficients, which are converted into wideband CELP format formant parameters in the step (a), into a coefficient in a type appropriate to formant coefficient interpolation; and
(b8) converting the formant coefficients, which are obtained in the step (b3) through interpolation, into formant coefficients appropriate to the PWF.

27. The method of claim 25, wherein the step (b2) comprises:
(b2_{—}1) converting the narrowband excitation signal generated in the step (b1) into a low band of a wideband excitation signal having a sampling frequency corresponding to a wideband CELP format;
(b2_{—}2) regenerating an excitation signal component corresponding to the high band of a wideband excitation signal, from the narrowband excitation signal generated in the step (b1);
(b2_{—}3) extracting only an excitation signal component corresponding to the high band of a wideband excitation signal, by high pass filtering the excitation signal reproduced in the step (b2_{—}2); and
(b2_{—}4) generating a wideband excitation signal by adding the low band excitation signal generated in the step (b2_{—}1) and the high band excitation signal generated in the step (b2_{—}3).

28. A computer readable medium having embodied thereon a computer program for executing any one method of claims 18 through 27.
